(19) United States
(12) Patent Application Publication
(10) Pub. No.: US 2013/0333382 A1
(43) Pub. Date: Dec. 19, 2013

(54) Power Source Machinery

(71) Applicants: HeungTung Li, Hongkong (CN); ChunMan Li, Hongkong (CN)

(72) Inventors: HeungTung Li, Hongkong (CN); ChunMan Li, Hongkong (CN)

(21) Appl. No.: 13/992,716

(22) PCT Filed: Dec. 8, 2011
(86) PCT No.: PCT/CN11/83711

§ 371 Date: Aug. 30, 2013

(30) Foreign Application Priority Data
Dec. 8, 2010 (CN) 201010579959.7

(51) Int. Cl. F03G 7/00

(52) U.S. Cl. CPC F03G 7/00
USPC 60/639; 60/495

(57) ABSTRACT

The present invention is a power source machinery. The power source machinery has following functions. Firstly, a slow cyclic flow is generated in a first period, and a quick and slow cyclic flow is generated in a second period. Secondly, a first huge generator drives a cylinder to rotate slowly from beginning to end, and outputs a lot of electric energy. Thirdly, supply of rotary power to a second generator and a third generator is stopped, and the rotary power is transferred to a gas pump and a water pump, which are rotating to finish the quick cyclic flow. In every period, the quick flow raise liquid in a single water-caltrop-shaped element in a lower portion to a single water-caltrop-shaped element in a higher portion, which has a function of lever, in such a manner that the power source machinery rotates continuously for a long period.

### CROSS REFERENCE OF RELATED APPLICATION

This is a U.S. National Stage under 35 U.S.0 371 of the International Application PCT/CN2011/083711, filed Dec. 08, 2011, which claims priority under 35 U.S.C. 119(a-d) to CN 201010579959.7, filed Dec. 08, 2010.

### BACKGROUND OF THE PRESENT INVENTION

1. Field of Invention

The present invention relates to a power source machinery, which is eco-friendly, operates under a room condition, does not pollute the environment, and can rotate and operate automatically without foreign energy inputted, wherein the power source machinery comprises three huge generators.

2. Description of Related Arts

Human intelligence develops rapidly since the 20th century. When creating great wealth, harmful by-products are brought at the same time, which causes environment damage, wherein the environment damage is more and more serious as time goes on, and many disasters are caused by the environment damage.

Nowadays, many countries focus on the environment protection, and put an enormous sum of money on the development of green energy to protect the ecological environment of the earth. However, there is an adverse tendency in reality: Many big financial groups want to make large fortune by grasping the economic fate, venality, and dominating the country. They don't care about healthy of human beings, environment protection in the world, and the future of mankind.

With the rapid development of human population in later years, a large number of energy is required badly to support the society developing rapidly. However, the new energy developed is more and more expensive, and the living standard of urban and rural citizen is hard to improve.

Although accidents in coal, oil, and nuclear industries cause environment pollutions and do harm to human's health for a long time, nowadays the development scale of nuclear energy is still increased gradually in many countries all over the world regardless of people's health and safety, which is not expected.

Although solar energy, wind energy, tidal energy, and combustible ice energy open new scientific ways, the green energy developed by investing large amounts of money is more and more expensive, and it is hard to improve the living standards of poor people to narrow the gap between the rich and the poor.

Once the power source machinery in the present invention is used widely, eco-friendly and cheap electricity is generated for the world, and all fuel power plants including nuclear power plants will be eliminated entirely under the objections of people.

### SUMMARY OF THE PRESENT INVENTION

Three generators in a rectangular reinforced concrete chamber weighing a thousand tons or ten thousand tons output electric energy to supply the city. A power source machinery comprises two parts, i.e., a rotating part, and a non-rotating part in mechanical structure. Each of the part comprises three components. Firstly, the three components of the rotating part are: (a) a cylinder; (b) a rotating axle; and (c) a whole ring connected in the front.

Secondly, three components of the non-rotating part are: (a) the rectangular reinforced concrete chamber; (b) three air chambers with three generators; and (c) an axle ring, which cannot rotate but can shift. Details are described as follows.

The power source machinery comprises two parts, i.e., the rotating part, and the non-rotating part in mechanical structure. Each of the part comprises three components. Firstly, the three components of the rotating part are: (a) a cylinder ring, called the cylinder for short, wherein 16 rectangular boards divide the cylinder into 16 same single water-caltrop-shaped elements, a plurality of fixing cylinder separators are provided in a plurality of positions in each of the single water-caltrop-shaped elements, pumps in series are against a shell of each of the single water-caltrop-shaped elements, the single water-caltrop-shaped elements in the left half of the cylinder are filled with liquid, and the single water-caltrop-shaped elements in the right half of the cylinder are filled with gas, except two flowing channels on the left and the right of a quick cyclic flow, other single water-caltrop-shaped elements rotates in sealed states, and do not disturb each other, beside shells of the two flowing channels on the left and the right of the axle ring of the quick cyclic flow, a lubricating long ruler for stopping leak is provided, although there is few obstruction, matter in each of the single water-caltrop-shaped elements will not flow to adjacent single water-caltrop-shaped element; (b) the rotating axle, wherein the rotating axle only bear part of weight of the cylinder, two ends of the axle are fixed on a reinforced concrete wall with bearings, and the rotating axle becomes a rotating center of the cylinder; and (c) a rotating whole ring connected in the front, positioned in another synchronized rotating ring, which is adjacent to the cylinder and the front of the axle, and connected with the cylinder via small circles, wherein a big wheel with small teeth is provided around the rotating whole ring, the rotating whole ring, the synchronized rotating ring, and the big wheel with small teeth are connected to form a whole ring rotating with the cylinder synchronously, between the cylinder and the axle, because of being separated by a non-rotating axle ring, a long bar is used to connect the cylinder and the axle to form a rotating whole, space of a non-rotating air chamber is provided surrounding the rotating whole, a pump gear chain ring belt outside a cover of the rotating cylinder is provided surrounding the space of non-rotating air chamber, when the rotating cylinder is required to change a project, the power of the cylinder is transfer to the generators or the pumps by an automatic key.

The three components of the non-rotating part are: (a) the rectangular reinforced concrete chamber; (b) three air chambers with the three generators; and (c) an axle ring, which cannot rotate but can shift.

(a) The volume of the rectangular reinforced concrete chamber is calculated by:

10 m²*100 m=1100 m³.

The volume of water in half of the cylinder in the chamber is calculated by:

9 m²*3.142×0.5×105 m=4658.66 m³.

This is a large-scale mould cylinder, which can only contain less than 0.5 ton of water, and is not useful for the power source machinery.

Rectangular reinforced concrete chambers weighing a hundred tons or a thousand tons are used for large-scale power plant and power source machinery in other industries.

(b) Three air chambers with three generators mean that the three generators are provided in the three air chambers. One of the generators provides electric energy to outside for two periods. Rotating of the other two generators are stopped by the automatic key in the second period, and the power is transferred to a gas pump in a higher portion and a water pump in a lower portion, in such a manner that operation of the quick cyclic flow is finished.

(c) The design of the axle ring, which cannot rotate but can shift is described as follows. In the first period, the non-rotating axle ring is located in a position of a vertical diameter of a semi-cycle. The two flow channels in a higher portion and a lower portion are sealed by a long bar all the time.

Once entering into the second period, the non-rotating axle ring move with the cylinder synchronizedly. The two flowing channels are opened in the second period. Synchronized moving simplifies a structure of the cylinder. The two flowing channels of the quick cyclic flow are guaranteed to be unimpeded in the second period.

The two cyclic flows in the present invention, i.e., the quick cyclic flow, and the slow cyclic flow, are generated by the three huge generators. The two periods, i.e., a slow period and a quick and slow period are preset. During alternating of the two periods, two successful factors are created.

1. First successful factor is the slow cyclic flow in the first period. Two achievements are obtained, i.e., (a) and (b).

(a) Slow rotating doesn't mean that the power are wasted. The power drives the three huge generators to generate electricity to supply the outside.

(b) An extremely slow rotating is created to ensure that there is sufficient time for the quick cyclic flow to be finished in the second period.

2. Second successful factor is the the quick and slow cyclic flow in the second period. The three generators are all used to generate electricity to supply the outside originally. Now only one of the generators generates electricity to supply the outside, and the other two generators are stopped rotating. The power is transferred to the gas pump on the higher portion and the water pump on the lower portion by the automatic key to realize operation of the quick cyclic flow. Mean while, the cylinder still rotates extremely slowly in the first and second period, and still at the slow cyclic flow.

The two successful factors and the rectangular reinforced concrete chambers weighing a hundred tons or a thousand thons help to benefit all mankind, and narrow the gap between the rich and the poor.

The second successful factor of the present invention is the quick and slow cyclic flow in the second period, the power of the cylinder is transferred to the gas pump in the higher portion and the water pump in the lower portion by the automatic key. The quick cyclic flow is finished by the mechanical conveyance system having a high efficiency and the expedite flowing channels.

A ratio between the two cyclic flows is applied in the quick and slow cyclic flow in the second period. In the slow cyclic flow, a number of centers of gravity of the single water-caltrop-shaped element is 7, a length of the lever is 2.3, a stroke is 1, and a total ratio is 16.4. In the quick cyclic flow, the number of centers of gravity of the single water-caltrop-shaped element is 1, a length of the lever is 1, a stroke is 7.8, and a total ratio is 7.8.

The ratio between the two cyclic flows shows a key point of the successful factors, which is that consumption of the quick cyclic flow is less than a half of the power of the slow cyclic flow, in such a manner that the cylinder rotates continuously.

The efficiency of the mechanical conveyance system is more than 99.999%, so the loss is calculated by:

1000 ton*(100%-99.999%)=1000 ton*0.001=1 ton

Actually, friction generated by the mechanical conveyance system is much less than the value shown above.

The three generators in the rectangular reinforced concrete chamber weighing a hundred tons or a thousand tons generate electricity to supply the city, and which can be used in various industries.

(1) High-speed safe tunnel can resist earthquake and disaster.

(2) Many rectangular reinforced concrete chambers superposed and spaced in seafloor are used to built seafloor farm.

(3) The chambers are used as foundation of a new building, the three generators in the rectangular reinforced concrete chamber weighing a hundred tons or a thousand tons output electricity to supply the whole building.

(4) A subterranean layer in marshland become scientific seafloor farm, and space on the subterranean layer can be used for residence, modern traffic safe tunnels, scientific farm, etc.

Finally, specific requirements of the liquid and the gas in the power source machinery is as follows.

In the rectangular reinforced concrete chamber weighing a hundred tons, or a thousand tons, an operator enters into an active door firstly, the cylinder is fixed, in such a manner that the cylinder cannot rotate. The liquid is injected into left half of the cylinder, and then gas in a right half is replaced. The cylinder begins to rotate after the power source machinery is detected, and there is no problem. Then the chamber is sealed after the power source machinery is detected again, and there is no problem.

The liquid is injected firstly, and then the gas is replaced. The liquid and the gas of high pressure inputted at one time can be used for a long period. Effects that changes of environmental temperature puts on physical characteristics of the liquid and the gas are considered.

Requirements of the gas and the liquid are as follows.

The gas comprises: air, helium, which is an inert gas.

1. The liquid is embodied as saturated saline solution. Because the saline solution having a high concentration crystallizes at minus 16 degrees, the saline solution having the high concentration is much heavier than water.

2. The liquid is embodied as water, which is nonreactive, cannot expand and contract excessively under the changing of the environmental temperature.

The power source machinery in the present invention is innovative, and eco-friendly. The power source machinery operates under a room temperature. The power source machinery does not pollute the environment, and the power source machinery can rotate and operate automatically without foreign energy inputted. The power source machinery can output a lot of electricity, which is eco-friendly and cheap.

These and other objectives, features, and advantages of the present invention will become apparent from the following detailed description, the accompanying drawings, and the appended claims.

### DETAILED DESCRIPTION OF THE PREFERRED EMBODIMENT

The present invention relates to a power source machinery, which is eco-friendly, operates under a room condition, does not pollute the environment, and can rotate and operate automatically without foreign energy inputted, wherein the power source machinery comprises three huge generators.

The present invention has three substances.

A first achievement of the present invention is as follows. The three huge generators are installed to drive the cylinder to rotate slowly, in such a manner that eco-friendly and cheap electricity is generated to benefit all mankind

A second achievement of the present invention is as follows. The cylinder uses ¼ of the power automatically and repeatedly. The quick cyclic flow is executed. The lever function of the liquid in the single water-caltrop-shaped element is improved, and an uninterruptible power source is created.

A third achievement of the present invention is as follows. The cylinder transfer 75% of the power to the three huge generators, and 25% of the power to rotating pumps through the mechanical conveyance system having the high efficiency of 99.999%. The loss of the power of the cylinder is reduced to the greatest extent.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

### THE BENEFICIAL EFFECTS OF THIS INVENTION

Once numerous (more than a million) reinforced concrete chambers weighing a hundred tons and a thousand tons with power source machineries are manufactured, eco-friendly and cheap electricity can be provided by the power source machineries, and various scientific industries with many application are created.

1—Seafloor power plant and sea farm are paved in bottom of high sea.

2—Traffic safe tunnels resists landslide and natural disasters are paved in rugged mountainous areas.

3—Warm towns are built up in cold regions, where icebergs and snowfields often occur.

4—Aquaculture farms are build in subterranean layer of marshland and industries required on the platform.

5—Foundations under buildings, which is safe and could provide electricity, are built in subterranean layer.

6—Large-scale power plants are built in subterranean layer in cities expanded newly, and the landslip of underground soil is resisted.

The above projects are useful, and three examples are taken as follows.

1—In the sea, numerous concave-convex paratactic cross walls avoiding holes are formed by chambers. concave-convex paratactic cross walls are deepened and paved to the seafloor of high sea. The cross walls form a broad slope platform in the seafloor. Under the broad platform, on one hand, large-scale power plants are built to provide eco-friendly and cheap electric energy. On the other had, inner space of the broad platform, which can be operated remotely, is used to develop industries of environmental protection and innovation.

a. The circulating inner space in the broad slope platform is used to build a large-scale sea remote controlled cultivating farm.

b. On the broad slope platform on the seafloor, a plurality of deep sea quakeproof safe tunnels are paved by coastal areas to create seafloor cargo transportation of various continents and various coastal areas, which can be used to transport fresh products speedily and can support remote driving.

2—On land, eco-friendly traffic tunnels formed by the chambers can generate electricity, and resist storms, heavy snow, and earthquake.

3—In marshland, a subterranean layer platform comprising an eco-friendly traffic tunnel is formed by the chambers. The chambers can generate electricity, and space on the subterranean layer can be used for industry, agriculture, pool, residence, etc.

Prospects in the future

The applicant has got application numbers of three inventions, i.e., (1) excellent code input method, (2) variable two-one motor, and (3) exploitation and application of combustible ice, oxygen, and hydrogen. The present invention, i.e., the power source machinery, is the fourth patent application. Two of the above inventions are important, i.e., the variable two-one motor comprising a variable two-one generator using a direct current and a low voltage, whose sensitivity, speed, and simulation are improved, and the excellent code input method, which is inputted by using database program, wherein an operator monitor and remotely control robots having high simulation, high sensitivity and high speed. Various tasks in the present invention is executed by automated system or semi-automated system.

The power source machinery is a first step to step into the future, which is a pioneer of many inventions of mine. The power source machinery and another invention, named electric energy appreciation, which has not been released yet, are two pioneers running together to lead other inventions. Under deployment of headquarter of scientific research institute, we develop scientific achievements hard to open up a wide innovation avenue for science and environmental protection. We contribute to narrow the gap between the rich and the poor, and benefit the whole mankind.

### BRIEF DESCRIPTION OF THE DRAWINGS

FIG. 1 is a front view of a cylinder and a structure view of a cover of the cylinder in a first period, i.e., type 17, an only slow cyclic flow, according to a preferred embodiment of the present invention. (Type 19 refers to a quick and slow cyclic flow.)

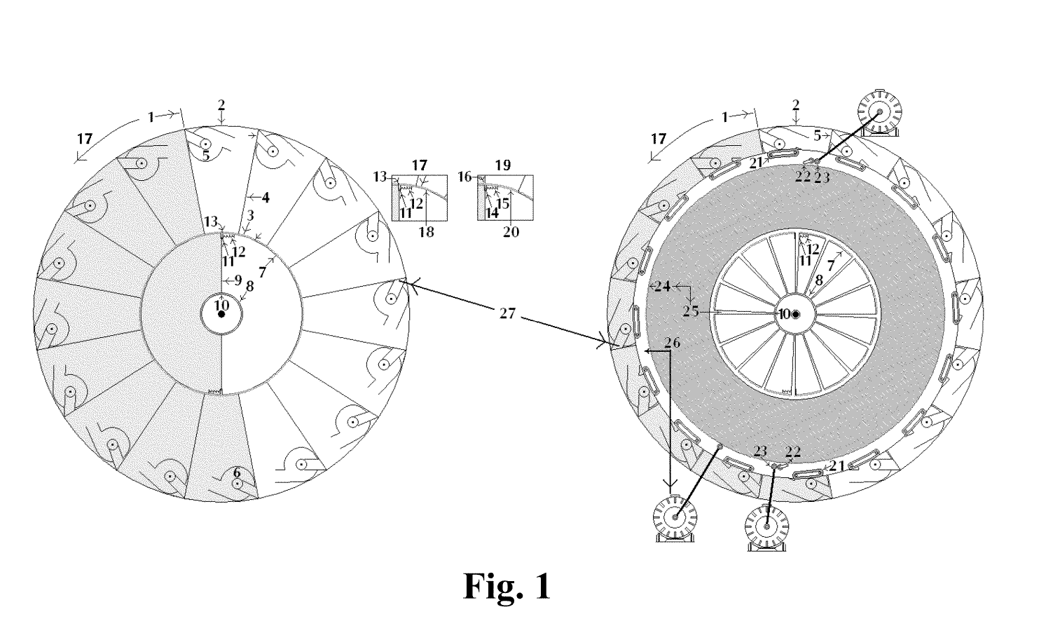

FIG. 2 comprises structure views of a front of cylinder and a side of the cylinder, when the cylinder is at a second [symbol] cell in the first period, i.e., type 17, the only slow cyclic flow, according to the preferred embodiment of the present invention.

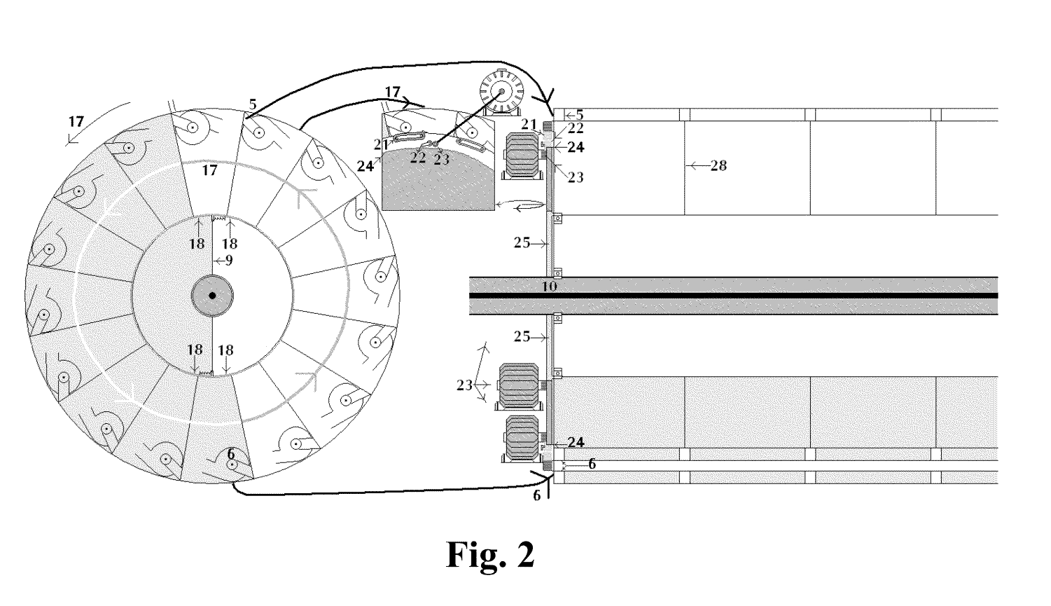

FIG. 3 is a front view of the cylinder, when the cylinder rotates to a third [symbol] cell and a fourth [symbol] cell in the first period , i.e., type 17, the only slow cyclic flow, according to the preferred embodiment of the present invention.

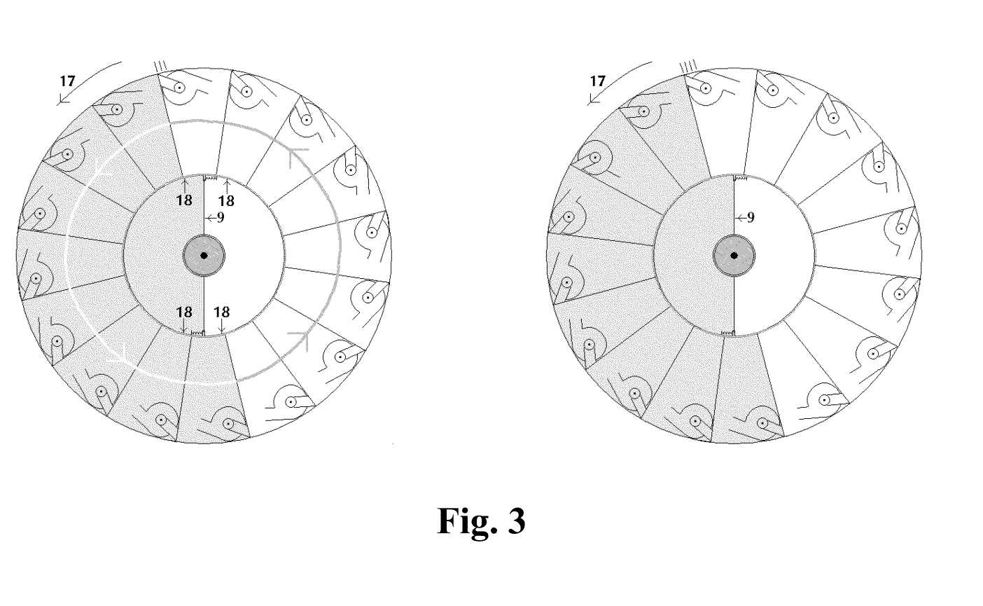

FIG. 4 is a front view of the cylinder, when the cylinder rotates to a fifth [symbol] cell and a sixth [symbol] cell in the first period , i.e., type 17, the only slow cyclic flow, according to the preferred embodiment of the present invention.

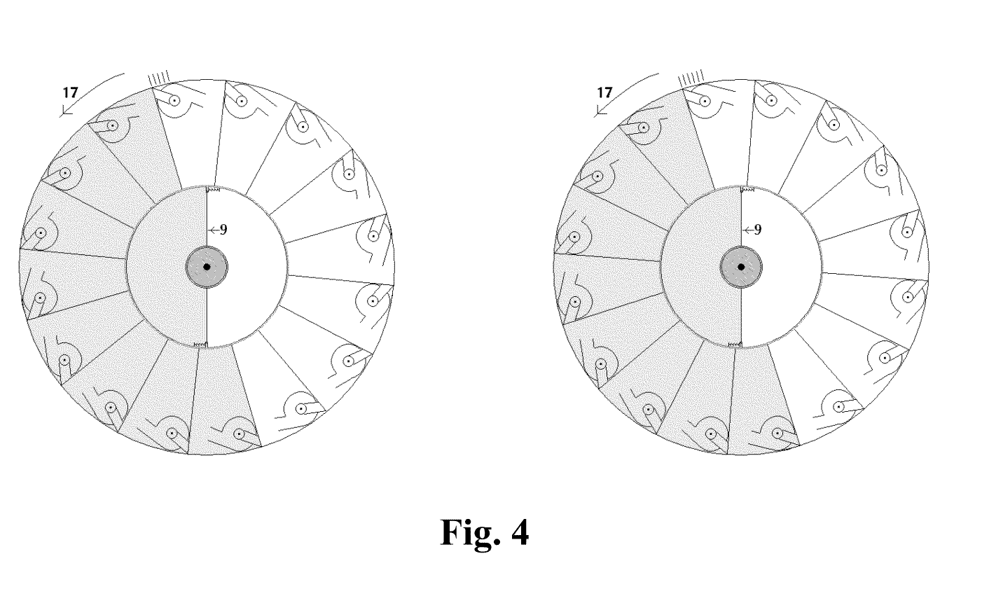

FIG. 5 is a front view of the cylinder, when the cylinder rotates to a seventh [symbol] cell and a eighth [symbol] cell in the first period , i.e., type 17, the only slow cyclic flow, according to the preferred embodiment of the present invention.

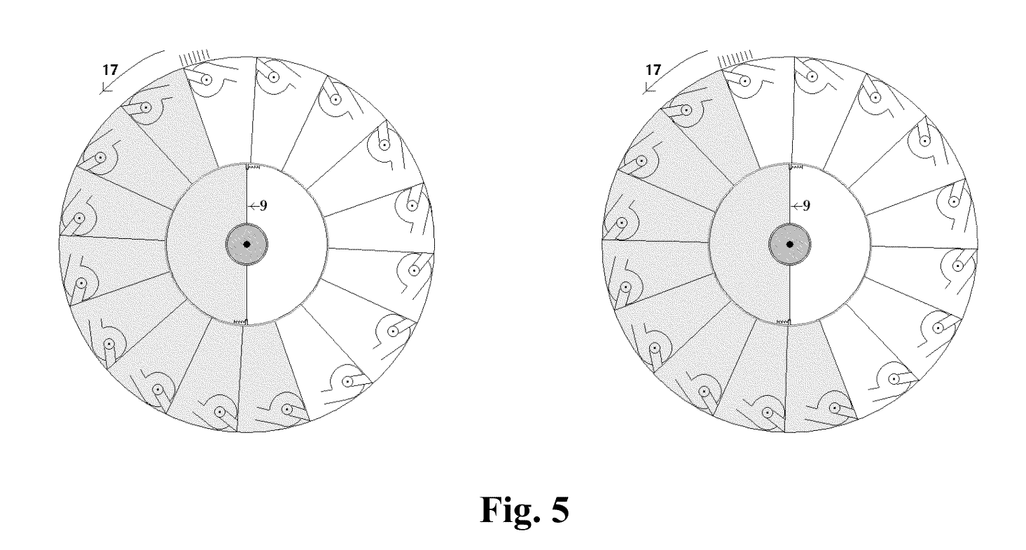

FIG. 6 is a front view of the cylinder and a structure view of the cover of the cylinder in a second period, i.e., type 19, the quick and slow cyclic flow, according to the preferred embodiment of the present invention.

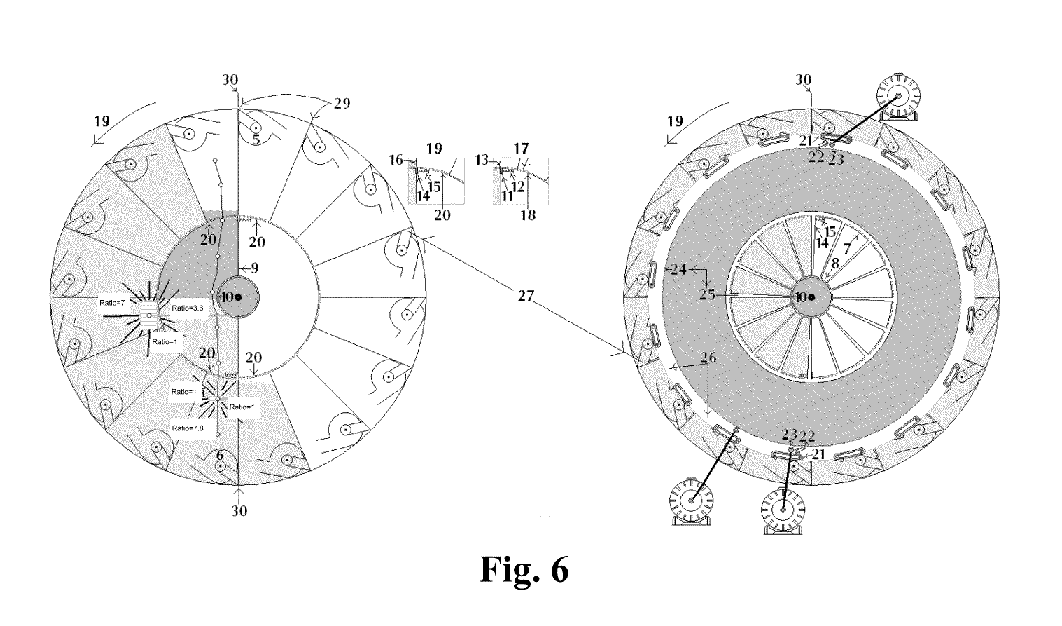

FIG. 7 comprises structure views of the front of cylinder and the side of the cylinder, when the cylinder rotates to the second [symbol] cell in the second period, i.e., type 19, the quick and slow cyclic flow, according to the preferred embodiment of the present invention.

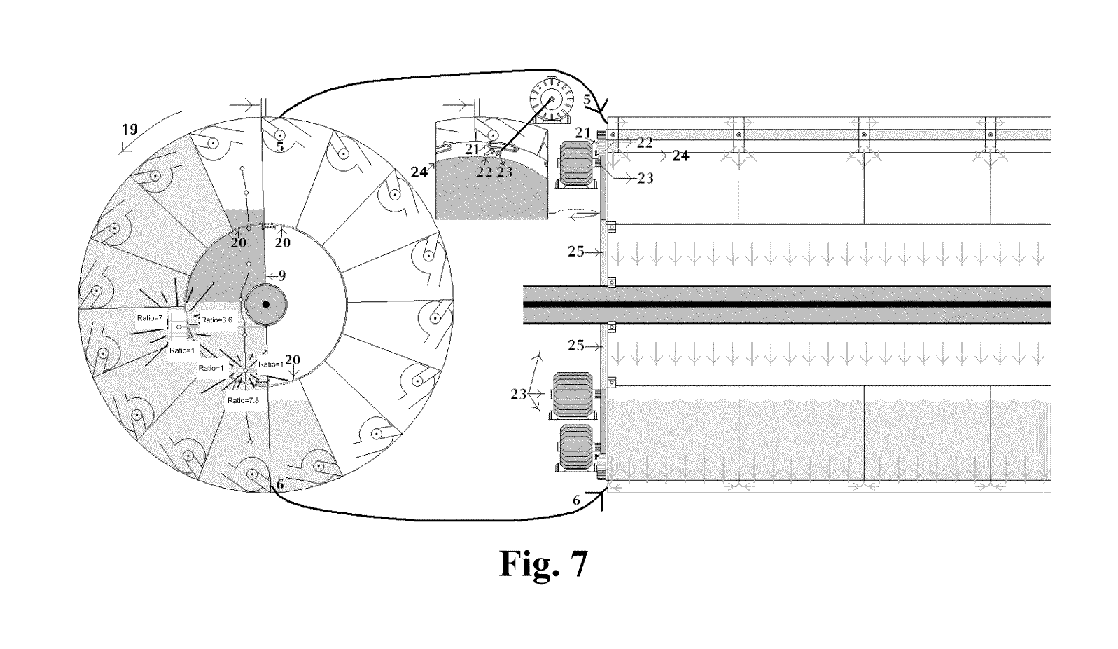

FIG. 8 comprises structure views of the front of cylinder and the side of the cylinder, when the cylinder rotates to the third [symbol] cell in the second period, i.e., type 19, the quick and slow cyclic flow, according to the preferred embodiment of the present invention.

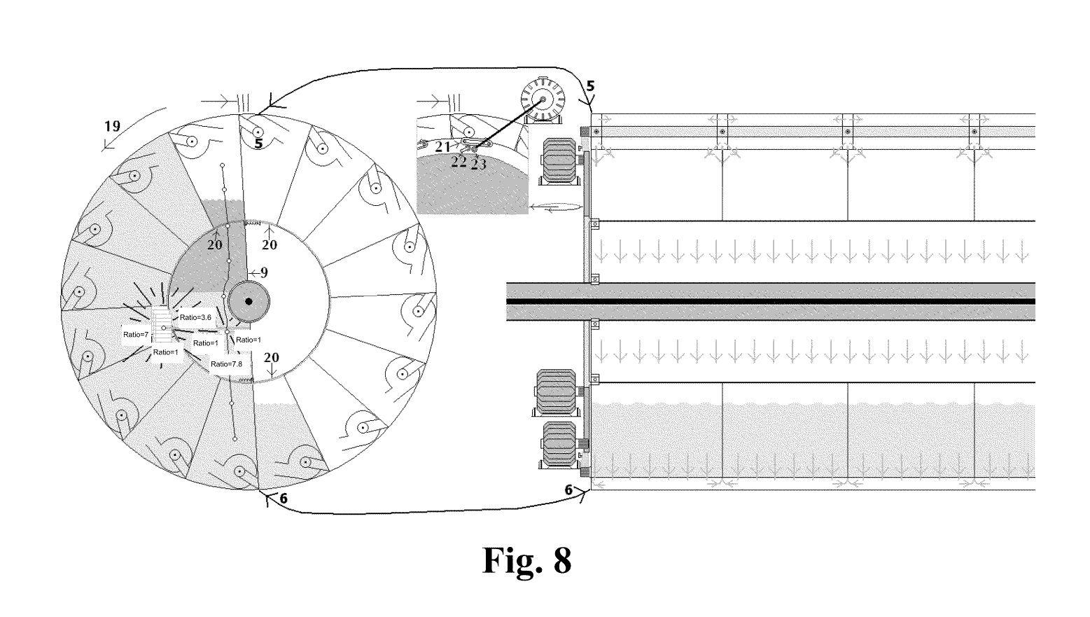

FIG. 9 comprises structure views of the front of cylinder and the side of the cylinder, when the cylinder rotates to the fourth [symbol] cell in the second period, i.e., type 19, the quick and slow cyclic flow, according to the preferred embodiment of the present invention.

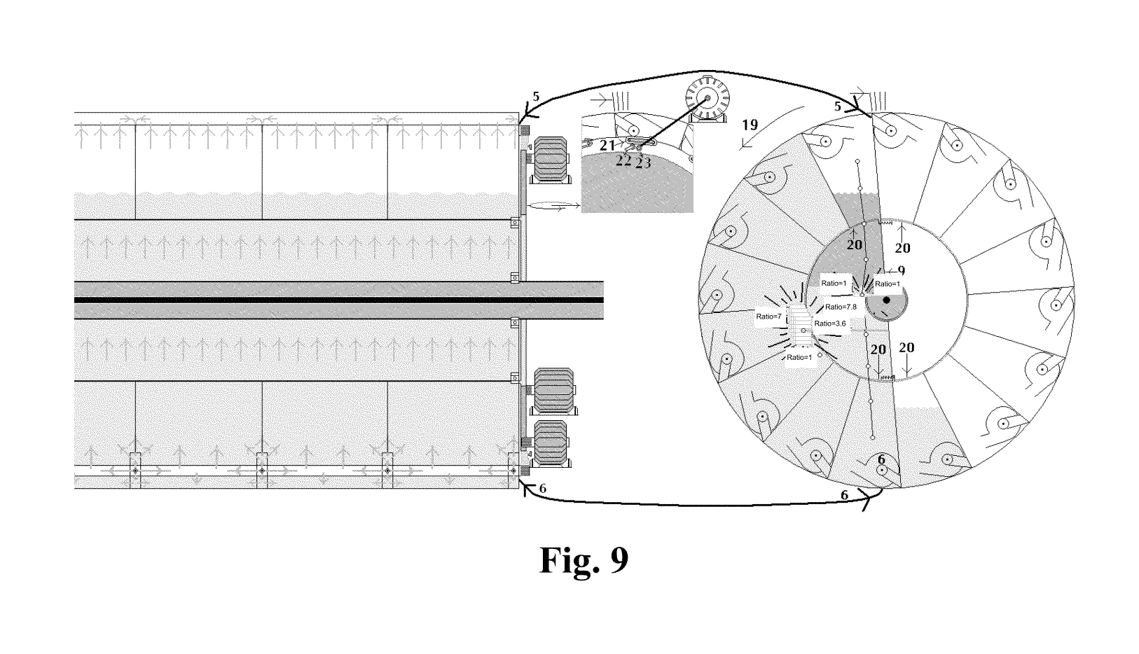

FIG. 10 is a front view of the cylinder, when the cylinder rotates to a fifth [symbol] cell and a sixth [symbol] cell in the second period, i.e., type 19, the quick and slow cyclic flow, according to the preferred embodiment of the present invention.

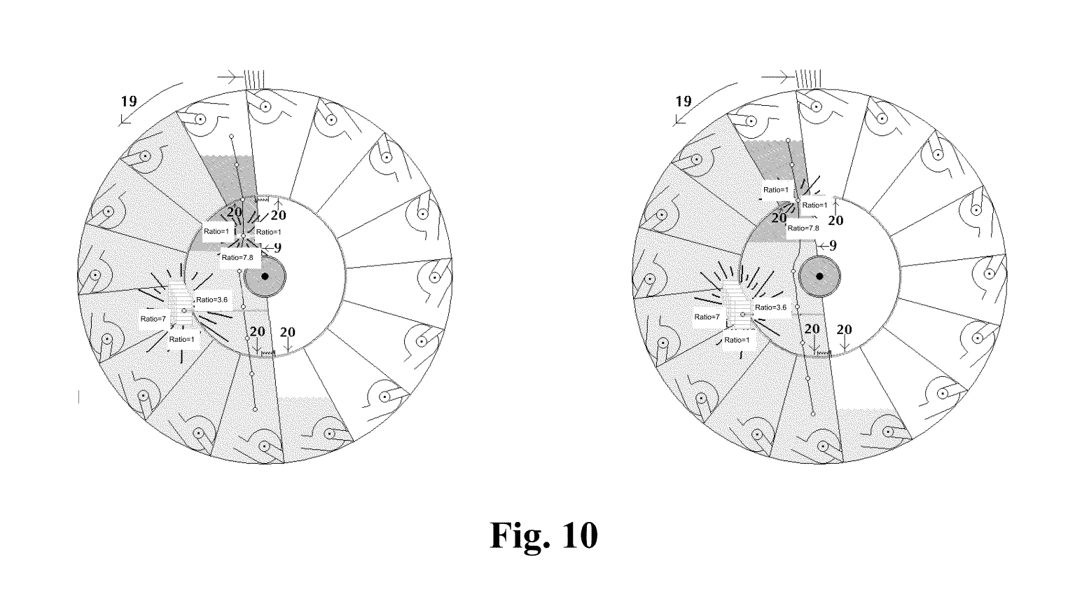

FIG. 11 comprises structure views of the front of cylinder and the side of the cylinder, when the cylinder rotates to the seventh [symbol] cell in the second period, i.e., type 19, the quick and slow cyclic flow, according to the preferred embodiment of the present invention.

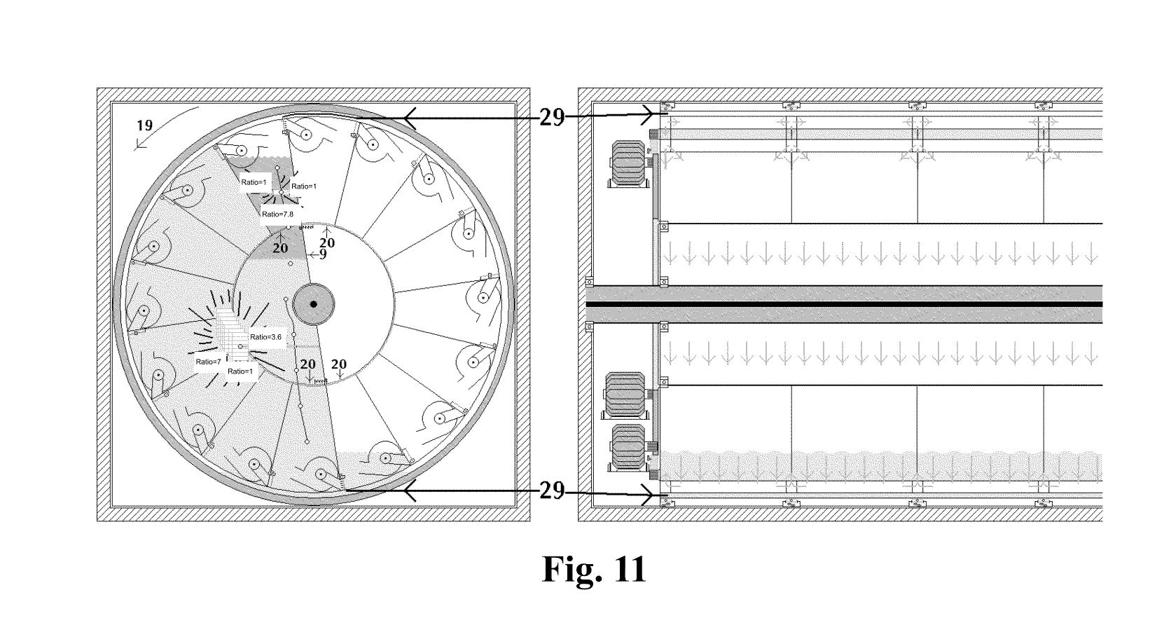

FIG. 12 comprises structure views of the front of cylinder and the side of the cylinder, when the cylinder rotates to the eighth [symbol] cell in the second period, i.e., type 19, the quick and slow cyclic flow, according to the preferred embodiment of the present invention.

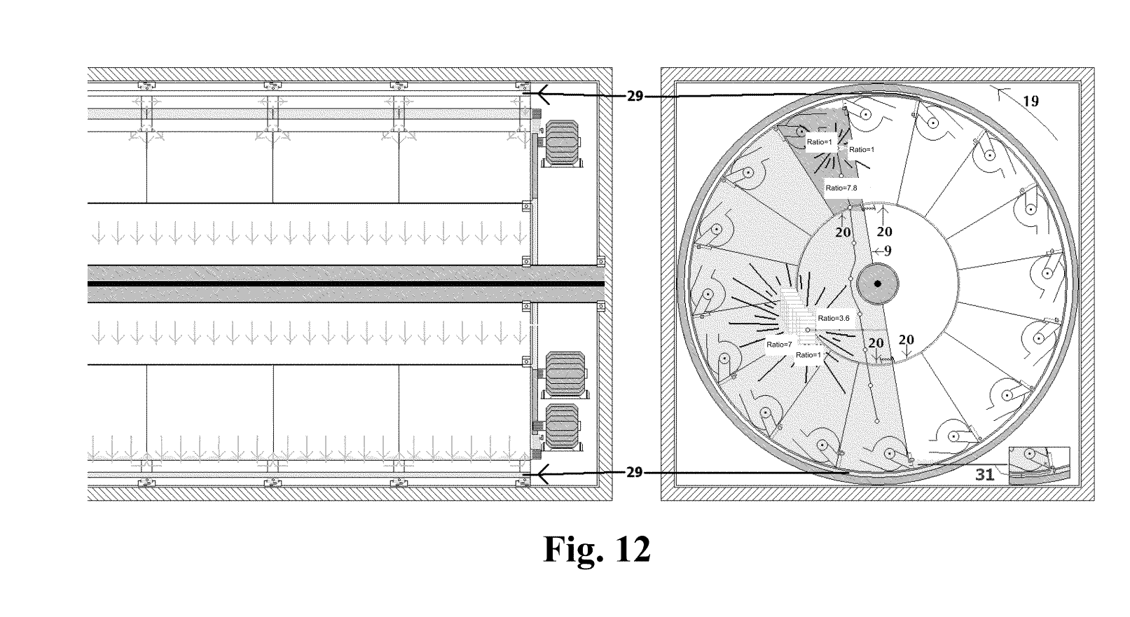

FIG. 13 is a sketch view illustrating that a gear switch key 22 starts generators to output electricity in the first period, i.e., type 17, the only slow cyclic flow.

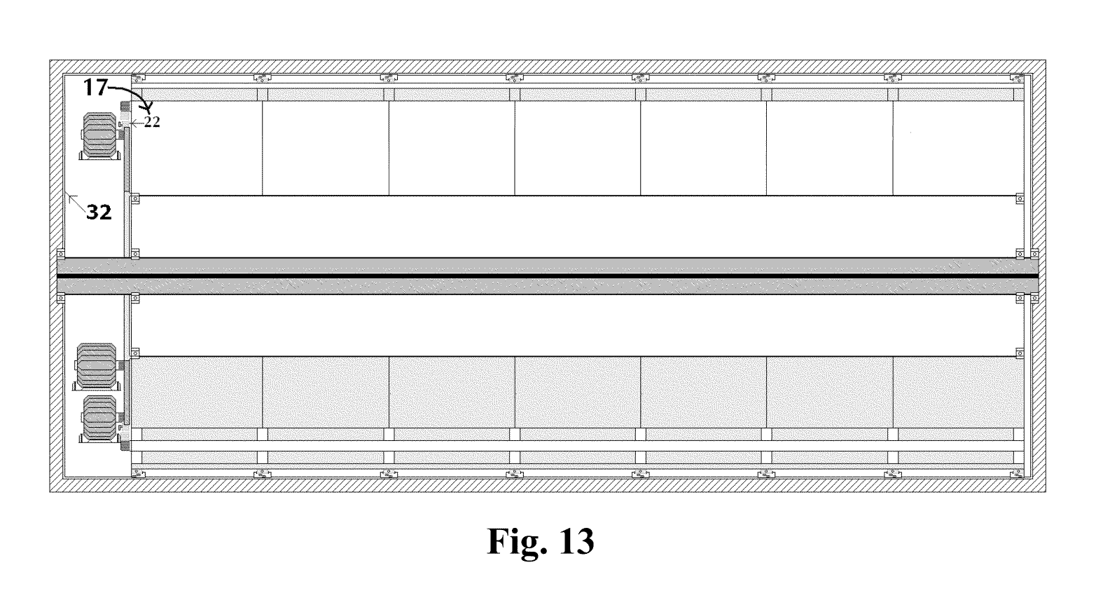

FIG. 14 is a sketch view illustrating that the gear switch key 22 starts pumps to finish a quick cyclic flow in the second period, i.e., type 19, the quick and slow cyclic flow.

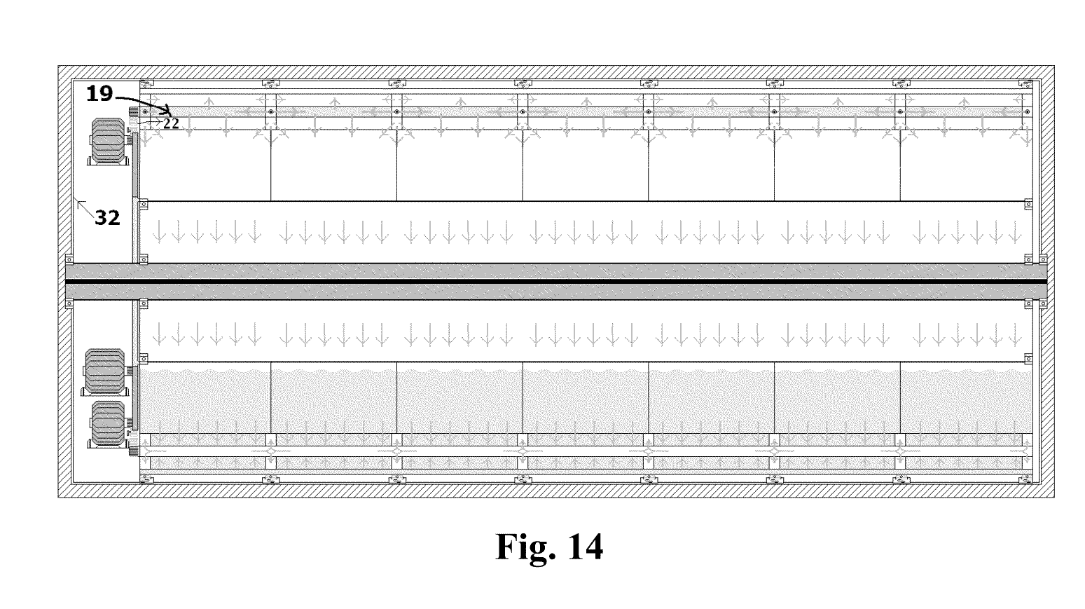

FIG. 15 a sketch view illustrating that numerous reinforced concrete chambers form a huge power plant and a farm on seafloor.

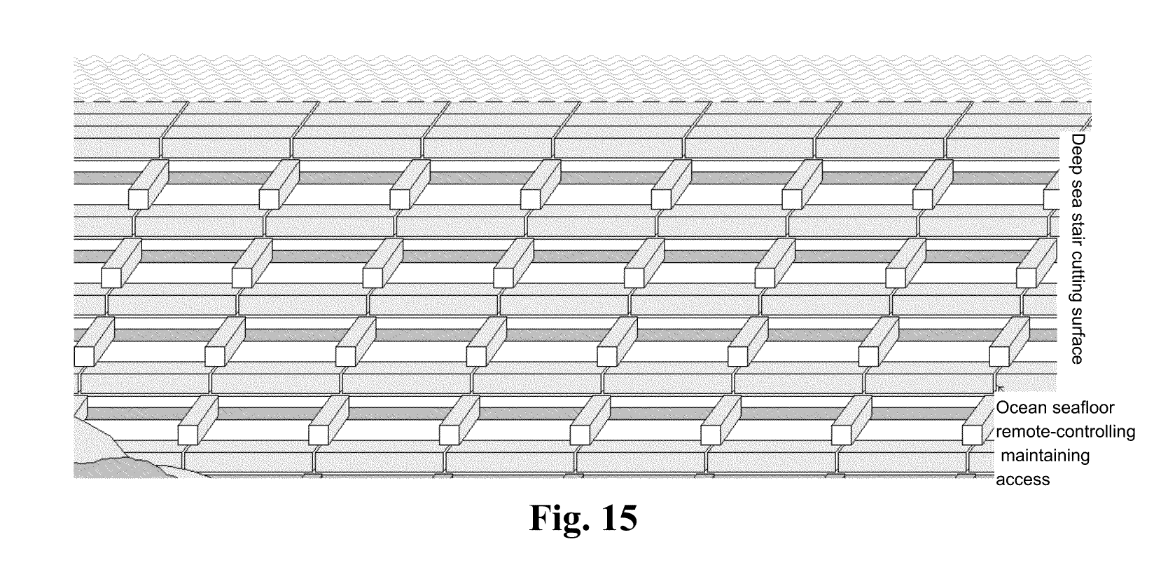

FIG. 16 is a sketch view illustrating that numerous reinforced concrete chambers form a growth place for shrimps, which can be remotely controlled by a user.

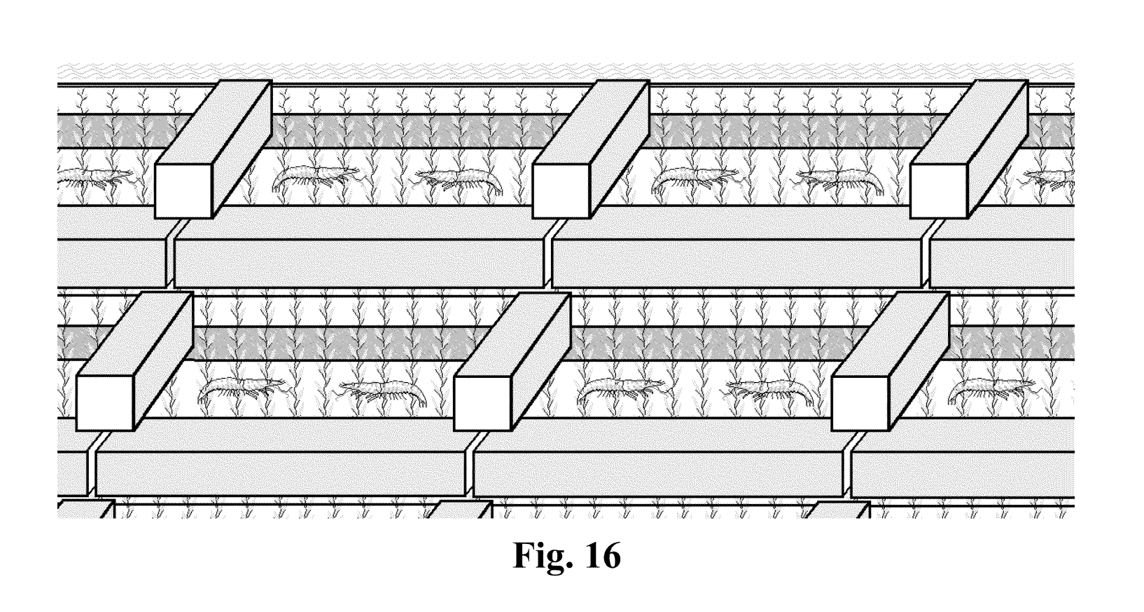

FIG. 17 a sketch view illustrating that numerous reinforced concrete chambers form a growth place for fish, which can be remotely controlled by a user.

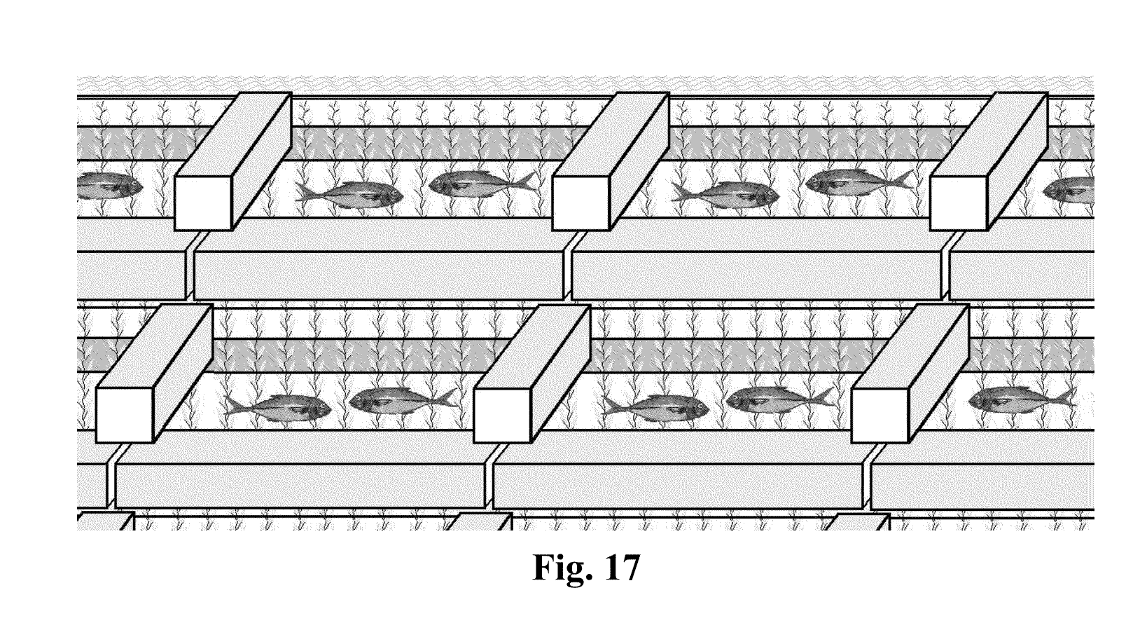

### DETAILED DESCRIPTION OF THE DRAWINGS

Components and functions of a power source machinery with rectangular reinforced concrete chambers weighing a hundred tons or a thousand tons are described as follows.

(1) positions of cells of a first stroke and a second stroke; (2) an outer shell of a cylinder; (3) an inner shell of the cylinder; (4) 16 separators of singe water-caltrop-shaped elements of the cylinder; (5) a gas pump in a higher position, comprising an inlet and an outlet; (6) a water pump in a lower position comprising an inlet and an outlet; (7) an outer shell of an axle ring, which belongs to a non-rotating part, but can move with the cylinder synchronizedly in the second stroke; (8) an inner shell of the axle ring; (9) an original vertical separator of the axle ring, which can move with the cylinder synchronizedly in the second stroke; (10) an axle.

The following components are only used in the first stroke.

(11) Two ends of a long bar, wherein a spring in an inserting frame is compressed in the first stoke, in such a manner that an end of an inserter is out of the inner shell to ensure that the cylinder rotates without outside disturbance; (12) another spring of the axle ring out of the inserting frame, which pull the axle ring back to a position of a vertical diameter during the first stroke, to guarantee that the axle will not move; (13) two flowing channels in the axle ring, which are sealed by the long bar during the first stroke.

The following components is used in the second stroke.

(14) When the second stroke starts, the end of the inserter of the outer shell of the axle ring inserts into the inner shell of the cylinder to guarantee that the axle ring move with the cylinder synchronizedly. (15) When the axle ring move with the cylinder synchronizedly, another spring of the axle ring is tensioned gradually, to guarantee that the axle ring goes back to the position of vertical diameter, when switching back to the first stroke. (16) During the second stroke, the long bars of the two flowing channels in the axle ring are opened, and the long bars are opened and closed by connecting a gear exchanging key,

(17) The first stroke of the cylinder (18) The axle ring seals both of the flowing channels by the gear exchanging key.

(19) The second stroke of the cylinder (20) The axle ring open both of the flowing channels by the gear exchanging key.

(21) Only when the gear exchanging key is at a higher position and a lower position, the first stroke and the second stroke can be executed. (22) When the first stroke is executed, the gear exchanging key respectively connects two generators with a big wheel with small teeth; when the second stroke is executed, the gear exchanging key respectively connects the gas pump in the higher position and the water pump in the lower position with the big wheel with small teeth. (A rotating speed of the gas pump in the higher position, which is driven by the gear exchanging key in the higher position, is larger than a rotating speed of the water pump in the lower position.) (23) a—A first achievement of three generators in the first stroke is that the cylinder finishes the slow cyclic flow. b—Rotating power provided to the two small generators is transferred. A second achievement in the second stroke is that while the cylinder is executing the slow cyclic flow, the quick cyclic flow is executed. (24) The big wheel with small teeth, wherein thousands of teeth are provided around the big wheel, and a number of the small teeth is depend on a rotating speed of the generators and the pumps, which is required to be achieved. (25) The cylinder and the axle separated by the axle ring, wherein the inner shell and the axle of the cylinder is shown. 16 plates rotate with the cylinder by being aligned with the 16 separators of the single water-caltrop-shaped elements. The big wheel with small teeth is provided around the 16 plates to form a strong thin ring. The small teeth around the big wheel play a vital role. (26) Air chambers of the three generators comprises: (a) generators; (b) the gear exchanging key provided on an outer ring of the big wheel with small teeth; (c) a toothed chain ring of the pumps provided on the cylinder; (27) In the rotating cylinder, except the gas in the higher position and the water in the lower position, pumps on two sides have no effects. (28) Single water-caltrop-shaped separators fixing the cylinder are provided in same positions of the single water-caltrop-shaped elements. (29) A plurality of lubricating rings bear most of weight of the cylinder, and keep the axle being a center of rotating. (30) Doors of inlets of the two pumps in the higher position and the lower position of the cylinder only open at a first cell in the second period. However, inside an upper single water-caltrop-shaped element in an eighth cell, before the door in the higher position is submerged by water, another port is opened by the door in the higher and the lower position to solve problems, in case that water are drained off completely or not completely. (31) Which of the doors open the port of the outer shell of the cylinder, the door in the higher position or in the lower position? A function of the pump is to use a little water in the lower position of the outer shell of the cylinder to solve small problems existing and to finish the quick cyclic flow. (32) A tight door is provided on a reinforced concrete wall of the rectangular chamber weighing a hundred tons or a thousand tons. The door is provided for detecting and maintain. Before the door is opened in the seafloor, peripheral link are only air ports, which is open downwards.

The power source machinery of the present invention has great faith to narrow the gap between the rich and the poor, and benefit all mankind.

1-5. (canceled)

6. A power source machinery, which is eco-friendly, operates under a room condition, does not pollute environment, and can rotate and operate automatically without foreign energy inputted, wherein said power source machinery comprises three huge generators;
said power source machinery comprises two parts, i.e., a rotating part, and a non-rotating part in mechanical structure; each of said part comprises three components; firstly, said three components of said rotating part are: (a) a cylinder; (b) a rotating axle; and (c) a whole ring connected in said front; secondly, three components of said non-rotating part are: (a) said rectangular reinforced concrete chamber; (b) three air chambers with three generators; and (c) an axle ring, which cannot rotate but can shift;
two cyclic flows in the present invention, i.e., a quick cyclic flow, and a slow cyclic flow, are generated by said three huge generators; two periods, i.e., a slow period and a quick and slow period are preset; during alternating of said two periods, successful factors are created, a first achievement is said slow cyclic flow, a second achievement is a quick and slow cyclic flow;
said second achievement is said quick and slow cyclic flow in said second period; said power of said cylinder is transferred to said gas pump in said higher portion and said water pump in said lower portion by said automatic key, said quick cyclic flow is finished by said mechanical conveyance system having a high efficiency and said expedite flowing channels; a ratio between said two cyclic flows is applied in said quick and slow cyclic flow in said second period; said ratio between said two cyclic flows shows a key point of said successful factors, which is that consumption of said quick cyclic flow is less than a half of said power of said slow cyclic flow, in such a manner that said cylinder rotates continuously;
said cylinder uses said mechanical conveyance system to transfer said power to reduce loss in said two periods;
said three generators in said rectangular reinforced concrete chamber weighing a hundred tons or a thousand tons generate electricity to supply the city, and which can be used in various industries, examples are as follows, high-speed safe tunnel can resist earthquake and disaster, many rectangular reinforced concrete chambers superposed and spaced in seafloor are used to built seafloor farm, said chambers are used as foundation of a new building, said three generators in said rectangular reinforced concrete chamber weighing a hundred tons or a thousand tons output electricity to supply said whole building, a subterranean layer in marshland become scientific seafloor farm, and space on said subterranean layer can be used for residence, modern traffic safe tunnels, scientific farm, etc., and
finally, specific requirements of said liquid and said gas in said power source machinery is as follows.

7. The power source machinery, as recited in claim 6, comprising two parts, i.e., said rotating part, and said non-rotating part in mechanical structure; each of said part comprises three components; firstly, said three components of said rotating part are: (a) said cylinder; (b) said rotating axle; and (c) said whole ring connected in said front; secondly, three components of said non-rotating part are: (a) said rectangular reinforced concrete chamber; (b) said three air chambers with three generators; and (c) said axle ring, which cannot rotate but can shift;
said power source machinery comprises two parts, i.e., said rotating part, and said non-rotating part in mechanical structure; each of said part comprises three components; firstly, said three components of said rotating part are: (a) said cylinder ring, called said cylinder for short, wherein 16 rectangular boards divide said cylinder into 16 same single water-caltrop-shaped elements, a plurality of fixing cylinder separators are provided in a plurality of positions in each of said single water-caltrop-shaped elements, pumps in series are against a shell of each of said single water-caltrop-shaped elements, said single water-caltrop-shaped elements in said left half of said cylinder are filled with liquid, and said single water-caltrop-shaped elements in said right half of said cylinder are filled with gas, except two flowing channels on said left and said right of a quick cyclic flow, other single water-caltrop-shaped elements rotates in sealed states, and do not disturb each other, beside shells of said two flowing channels on said left and said right of said axle ring of said quick cyclic flow, a lubricating long ruler for stopping leak is provided, although there is few obstruction, matter in each of said single water-caltrop-shaped elements will not flow to adjacent single water-caltrop-shaped element; (b) said rotating axle, wherein said rotating axle only bear part of weight of said cylinder, two ends of said axle are fixed on a reinforced concrete wall with bearings, and said rotating axle becomes a rotating center of said cylinder; and (c) a whole ring connected in said front, positioned in another synchronized rotating ring, which is adjacent to said cylinder and said front of said axle, and connected with said cylinder via small circles, wherein a big wheel with small teeth is provided around said rotating whole ring, said rotating whole ring, said synchronized rotating ring, and said big wheel with small teeth are connected to form a whole ring rotating with said cylinder synchronously, between said cylinder and said axle, because of being separated by a non-rotating axle ring, a long bar is used to connect said cylinder and said axle to form a rotating whole, space of a non-rotating air chamber is provided surrounding said rotating whole, a pump gear chain ring belt outside a cover of said rotating cylinder is provided surrounding said space of non-rotating air chamber, when said rotating cylinder is required to change a project, said power of said cylinder is transfer to said generators or said pumps by an automatic key;
said three components of said non-rotating part are: (a) said rectangular reinforced concrete chamber; (b) three air chambers with said three generators; and (c) an axle ring, which cannot rotate but can shift;
(a) said volume of said rectangular reinforced concrete chamber is calculated by:
10 m²*100 m=1100 m³;
said volume of water in half of said cylinder in said chamber is calculated by:
9 m²*3.142×0.5×105 m=4658.66 m³.
This is a large-scale mould cylinder, which can only contain less than 0.5 ton of water, and is not useful for said power source machinery;
rectangular reinforced concrete chambers weighing a hundred tons or a thousand tons are used for large-scale power plant and power source machinery in other industries;
(b) three air chambers with three generators means that said three generators are provided in said three air chambers; one of said generators provides electric energy to outside for two periods; rotating of said other two generators are stopped by said automatic key in said second period, and said power is transferred to a gas pump in a higher portion and a water pump in a lower portion, in such a manner that operation of said quick cyclic flow is finished;
(c) said design of said axle ring, which cannot rotate but can shift is described as follows, in said first period, said non-rotating axle ring is located in a position of a vertical diameter of a semi-cycle, said two flow channels in a higher portion and a lower portion are sealed by a long bar all the time;
once entering into said second period, said non-rotating axle ring move with said cylinder synchronizedly, said two flowing channels are opened in said second period. Synchronized moving simplifies a structure of said cylinder, said two flowing channels of said quick cyclic flow is guaranteed to be unimpeded in said second period.

8. The power source machinery, as recited in claim 6, wherein said two cyclic flows in the present invention, i.e., said quick cyclic flow, and said slow cyclic flow, are generated by said three huge generators; said two periods, i.e., a slow period and a quick and slow period are preset; during alternating of said two periods, successful factors are created, i.e., said slow cyclic flow, and said quick and slow cyclic flow;
said two cyclic flows in the present invention, i.e., said quick cyclic flow, and said slow cyclic flow, are generated by said three huge generators; said two periods, i.e., a slow period and a quick and slow period are preset; during alternating of said two periods, two successful factors are created, i.e., said slow cyclic flow, and said quick and slow cyclic flow;
a first successful factor is said slow cyclic flow in said first period. Two achievements are obtained, i.e., (a) and (b);
(a) slow rotating doesn't mean that said power are wasted, said power drives said three huge generators to generate electricity to supply the outside;
(b) an extremely slow rotating is created to ensure that there is sufficient time for said quick cyclic flow to be finished in said second period;
a second successful factor is said quick and slow cyclic flow in said second period, said three generators are all used to generate electricity to supply said outside originally, now only one of said generators generates electricity to supply said outside, and said other two generators are stopped rotating, said power is transferred to said gas pump on said higher portion and said water pump on said lower portion by said automatic key to realize operation of said quick cyclic flow, meanwhile, said cylinder still rotates extremely slowly in said first and second period, and still at said slow cyclic flow;
said two successful factors and said rectangular reinforced concrete chambers weighing a hundred tons or a thousand tons help to benefit all mankind, and narrow said gap between said rich and said poor.

9. The power source machinery, as recited in claim 6, wherein said second successful factor of the present invention is said quick and slow cyclic flow in said second period, said power of said cylinder is transferred to said gas pump in said higher portion and said water pump in said lower portion by said automatic key, said quick cyclic flow is finished by said mechanical conveyance system having a high efficiency and said expedite flowing channels, a ratio between said two cyclic flows is applied in said quick and slow cyclic flow in said second period, said ratio between said two cyclic flows shows a key point of said successful factors, which is that consumption of said quick cyclic flow is less than a half of said power of said slow cyclic flow, in such a manner that said cylinder rotates continuously;
said second successful factor of the present invention is said quick and slow cyclic flow in said second period, said power of said cylinder is transferred to said gas pump in said higher portion and said water pump in said lower portion by said automatic key, said quick cyclic flow is finished by said mechanical conveyance system having a high efficiency and said expedite flowing channels;
a ratio between said two cyclic flows is applied in said quick and slow cyclic flow in said second period, in said slow cyclic flow, a number of centers of gravity of said single water-caltrop-shaped element is 7, a length of said lever is 2.3, a stroke is 1, and a total ratio is 16.4, in said quick cyclic flow, said number of centers of gravity of said single water-caltrop-shaped element is 1, a length of said lever is 1, a stroke is 7.8, and a total ratio is 7.8;
said ratio between said two cyclic flows shows a key point of said successful factors, which is that consumption of said quick cyclic flow is less than a half of said power of said slow cyclic flow, in such a manner that said cylinder rotates continuously.

10. The power source machinery, as recited in claim 6, wherein said cylinder uses said mechanical conveyance system to transfer said power to reduce loss in said two periods;
said efficiency of said mechanical conveyance system is more than 99.999%, so said loss is calculated by:
1000 ton*(100%-99.999%)=1000 ton*0.001=1 ton;
actually, friction generated by said mechanical conveyance system is much less than said value shown above.

11. The power source machinery, as recited in claim 6, wherein said three generators in said rectangular reinforced concrete chamber weighing a hundred tons or a thousand tons generate electricity to supply the city, and which can be used in various industries, examples are as follows, high-speed safe tunnel can resist earthquake and disaster, many rectangular reinforced concrete chambers superposed and spaced in seafloor are used to built seafloor farm, said chambers are used as foundation of a new building, said three generators in said rectangular reinforced concrete chamber weighing a hundred tons or a thousand tons output electricity to supply the whole building, a subterranean layer in marshland become scientific seafloor farm, and space on said subterranean layer can be used for residence, modern traffic safe tunnels, scientific farm, etc.;
said three generators in said rectangular reinforced concrete chamber weighing a hundred tons or a thousand tons generate electricity to supply the city, and which can be used in various industries, examples are as follows;
(1) high-speed safe tunnel can resist earthquake and disaster;
(2) many rectangular reinforced concrete chambers superposed and spaced in seafloor are used to built seafloor farm;
(3) said chambers are used as foundation of a new building, said three generators in said rectangular reinforced concrete chamber weighing a hundred tons or a thousand tons output electricity to supply the whole building;
(4) a subterranean layer in marshland become scientific seafloor farm, and space on said subterranean layer can be used for residence, modern traffic safe tunnels, scientific farm, etc.

12. The power source machinery, as recited in claim 6, wherein specific requirements of said liquid and said gas in said power source machinery is as follows;
finally, specific requirements of said liquid and said gas in said power source machinery is as follows;
in said rectangular reinforced concrete chamber weighing a hundred tons, or a thousand tons, an operators enters into an active door firstly, said cylinder is fixed, in such a manner that said cylinder cannot rotate, said liquid is injected into left half of said cylinder, and then gas in a right half is replaced, said cylinder begins to rotate after said power source machinery is detected, and there is no problem, then said chamber is sealed after said power source machinery is detected again, and there is no problem;
said liquid is injected firstly, and then said gas is replaced, said liquid and said gas of high pressure inputted at one time can be used for a long period, effects that changes of environmental temperature puts on physical characteristics of said liquid and said gas are considered;
requirements of said gas and said liquid are as follows;
said gas comprises: air, helium, which is an inert gas;
(1) said liquid is embodied as saturated saline solution, because said saline solution having a high concentration crystallizes at minus 16 degrees, said saline solution having said high concentration is much heavier than water;
(2) said liquid is embodied as water, which is nonreactive, cannot expand and contract excessively under the changing of said environmental temperature;
said power source machinery in the present invention is innovative, and eco-friendly, said power source machinery operates under a room temperature, said power source machinery does not pollute the environment, and said power source machinery can rotate and operate automatically without foreign energy inputted, said power source machinery can output a lot of electricity, which is eco-friendly and cheap.
